(19) United States
(12) Patent Application Publication
(10) Pub. No.: US 2015/0347696 A1
(43) Pub. Date: Dec. 3, 2015

(54) HEALTHCARE EQUIPMENT SUPPLY CHAIN METHOD, PROCESS, AND SYSTEM

(71) Applicants: Thomas B. Mitchell, Fort Wayne, IN (US); Lanny L. Johnson, Frankfort, MI (US)

(72) Inventors: Thomas B. Mitchell, Fort Wayne, IN (US); Lanny L. Johnson, Frankfort, MI (US)

(21) Appl. No.: 14/728,974

(22) Filed: Jun. 2, 2015

Related U.S. Application Data
(60) Provisional application No. 62/006,872, filed on Jun. 2, 2014.

(51) Int. Cl. G06F 19/00

(52) U.S. Cl. CPC G06F 19/327

(57) ABSTRACT

A method, system, and computer program product for analyzing records of a healthcare provider, identify equivalent stable-technology equipment, and facilitate the direct purchase of stable-technology equipment by the healthcare provider from a stable-technology equipment supplier.

### CROSS-REFERENCE TO RELATED APPLICATIONS

This application claims the benefit of U.S. provisional patent application Ser. No. 62/006,872, filed on Jun. 2, 2014, all of which is incorporated by reference as if completely written herein.

### STATEMENT REGARDING FEDERALLY SPONSORED RESEARCH OR DEVELOPMENT

This invention was not made as part of a federally sponsored research or development project.

### TECHNICAL FIELD

The present invention relates to a method of aligning physician and hospital objectives to reduce the cost of medical procedures, which may include an outsourced implant management service system.

### BACKGROUND OF THE INVENTION

The traditional physician alignment with the institution is one of an independent contractor. The doctor was in private practice and was granted privileges on the hospital staff. There was no financial alignment with this relationship. The physician may, or may not, have a committee responsibility.

At the other end of the alignment spectrum is a relationship where the physician is a hospital employee. This alignment model is ever increasing frequency in recent years. The physician may have by contract with a vested financial interest related to performance. The physician would likely have administrative responsibility.

As health care has grown to more than 17% of the Gross Domestic Product (GDP) in the United States there has been increasing governmental controls and regulations in this sector of the economy. The Stark regulations and federal anti-kickback statutes have had major impact upon the practice of medicine. The rules and regulations affect the alignment of the physicians with the health care industry, clinics, and hospital. Continuing legislation limits the financial opportunities physicians may have with industry and or their institutions. In an attempt to eliminate payola and financial kickbacks, industry cannot any longer give a pen, pencil, or coffee cup to a physician.

There is a caveat in the law that states that the hospital's medical staffs private office is considered part of the institutions campus for the hospital investment; ie. medical records, video, electronic communication, etc. Since the government is the purchaser of health care for Medicare and Medicaid, they have established set fees for various services. The reimbursements are often less than the cost of rendering the services.

The physician faces an ever increasing overhead expense with national inflation, but more specifically to the cost of doing business in health care. For instance, the federal government has recently expanded the ICD-9 coding system for payment of 17,000 codes to the October 2014 ICD-10 system, which contains 155,000 different codes required for reimbursement of various medical conditions for the purpose of payment. One of the ridiculous examples is V9027XA: “Drowning and submersion due to falling or jumping from burning water-skis, initial encounter.” The reimbursement system by the very nature of the word implies a third party determined the value of the service, not the provider or the marketplace.

The socioeconomic nature of the health care industry differs from every other industry in regulation, pricing, and performance. Recent legislation calls for incentives for cost saving and penalties for non economical outcomes linked to morbidity and complications independent of the responsible party in Medicare and Medicaid.

Most business models of physician hospital alignment have been designed by government for cost cutting or by institutions for their interests. One exception to these programs was one with physician initiative. Application of Arthroscopy and Financial Warranty-Results of a Two Year Pilot Study. Arthroscopy. 1994; 10(4): 462-470. This proof of principle pilot study demonstrated how a physician initiative aligned with the hospital institution could offer a select group of patients health care at a lower price resulting in physician and hospital profiting more than under the standard reimbursement, as well as significant savings to the insurer. The profit margin that was exploited at that time was the difference offered by out-patient arthroscopy over in-patient surgery for similar problems. In addition the warranty was based upon the physician's and hospital administration's knowledge of the surgeon's complication rates. Both parties were willing to indemnify events that historically had not happened. The physician was willing to place $25,000 in an escrow account to warranty any unexpected events.

Subsequently many different physician hospital alignment systems have been proposed. They vary in the intensity of the relationship from “pay for call” or “co-marketing” on the low end to “value incentive programs” at the high alignment relationship.

The federal government has attempted to incentivize physician-hospital alignment by implementing regulations that contain several specific statutory exceptions, termed “safe harbors.” Compliance with a safe harbor removes a relationship or transaction from the risk of civil or criminal prosecution under the anti-kickback statute. To qualify for protection, an arrangement must satisfy all of the conditions for the statutory exception, or regulatory “safe harbor.”

There are several forms of these alignment structures, such as bundled payment/gain sharing, co-management, employment, clinically integrated network, and physician incentive program, which are designed to save the government money and earn management fees for the organizations administrating the services. There are incentive opportunities for the physician based upon cost saving performance, but overlooked is that at some point the performance cannot be increased and financial rewards for the physician come to an end. The Accountable Care Organization (ACO) is most recent of the federal government program.

There needs to be a novel approach to aligning the goals of the physician and the hospital to utilize the physician's expertise and financially reward them accordingly to provide the highest measured quality of health care in the most cost effective manner. Present methods do not fully recognize the value of the physician's input. The typical alignment lists the physician's value based upon time and effort, not expertise and judgment. Another method of compensation for the physician is determined by what a third party manager of a product line would receive. The physician's value cannot be equated with the education and background of a hospital product line manager, let alone on an hourly basis.

The US healthcare market is undergoing significant change. The market is heading toward value-based purchasing, yet there are still substantial fee-for-service reimbursement needs to service. This creates operational challenges, as providers need to prepare for the future while not creating an adverse financial situation in the short term.

In addition to reimbursement reform, a major shift is emerging in physician preference items, referred to as PPI. Most PPI implants are now time-tested designs. These time-tested devices deliver excellent clinical results, but require providers to acquire new knowledge and develop new skill sets, as value-based purchasing has no middlemen support. Providers must learn to manage their orthopedic service with no sales representative support, which will dramatically lower their procurement costs for implants, which today comprise the largest over-all cost of reimbursement.

Consequently health systems that are serious about transforming themselves must harness the energy, unique skills and collaboration of their physicians. Presently physicians drive PPI decisions, so this creates a significant process change for everyone (suppliers, hospital leadership, payers, clinicians, and physicians). Gaining alignment with surgeons is mission critical to lowering healthcare cost and to date has been the single biggest barrier to change.

Market forces have been converging for many years, including economic drivers, an aging population, governmental influence (Accountable Care Act) has fueled the “total cost of care” in the US healthcare industry. Although the rate of growth in our healthcare spending has slowed in recent years, expenditures continue to rise. The United States now devotes almost 18 percent of its GDP to healthcare. Significant transformational change throughout the orthopedic supply chain, and more broadly the medical equipment supply chain, is needed to implement value-base procurement. This magnitude of change requires robust leadership, and much of that leadership must come from clinicians, especially physicians. Part of the solution requires hospitals to “take-back” responsibilities that have been traditionally managed by suppliers. Customers support programs like, consigned inventory; marketing incentives, training and logistics support contribute more to the total cost for the hospitals than the actual cost of goods for the devices.

Physicians not only make frontline decisions that determine the quality and efficiency of care for the patent, they have the technical knowledge and unique experience, and they are central to transforming the delivery model and must be intimately involved in the change process. Simply stated, coalescing suppliers, payers, and providers is necessary to successful implement value-based reimbursement, the value stream of care delivery is changing, and this requires a new breed of physician leaders.

The current provider alignment structures have been met with significant resistance from physicians. They are perceived as being either too confining or too difficult to understand, and they foster a high aversion to change feelings because they don't understanding of the long-term implications/benefits. These attitudes, combined with low relational trust between physicians and hospital management, which has been festering for many years, creates significant change barriers. The inability to engage physicians to participate as a positive change advocate paralyzes any alignment solution.

Health systems that want to deliver cost effective and quality solutions of care must find ways to overcome these historic barriers. As such, providers must develop a true capability to engage physicians via an organizational structure that is broader than the existing management tool options. The structure needs to be simple to understand and empower physicians, whether they are employees or in a private practice, and must align the goals of the physician with the hospital objectives. Hospital needs to utilize the physician's expertise and financially reward them accordingly to provide the highest measure of quality of health care in a cost effective manner. The current alignment methods are top-down management driven initiatives. Documented change management evidence demonstrates that 70% of all top-down change initiatives fail and are not sustainable. The existing alignment methods acknowledge the physician's value contribution based on time and effort, but not their expertise, judgment and leadership. The physician's value cannot be equated with the education and background of a hospital service line manager, let alone on an hourly basis.

Therefore it is reasonable that a novel approach to physician-hospital alignment be such that the physician continues to be at risk and responsible for their actions. Furthermore the physician should be financially compensated for expertise, knowledge, experience and judgment, none of which would be compensated as labor, but rather that of high level executive management. One such novel physician hospital alignment method is subject of this patent application. In this method the physician is compensated for his training experience, expertise, knowledge, and judgment in decision making concerning patient care, and complies with the federal laws.

### BRIEF DESCRIPTION OF THE DRAWINGS

Without limiting the scope of the present method, system, and program, referring now to the drawings and figures:

FIG. 1 shows a schematic illustration of one embodiment of the invention;

FIG. 2 shows a schematic illustration of one embodiment of the invention; and

FIG. 3 shows a schematic illustration of one embodiment of the invention.

These figures are provided to assist in the understanding of exemplary embodiments as described in more detail below and should not be construed as unduly limiting. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

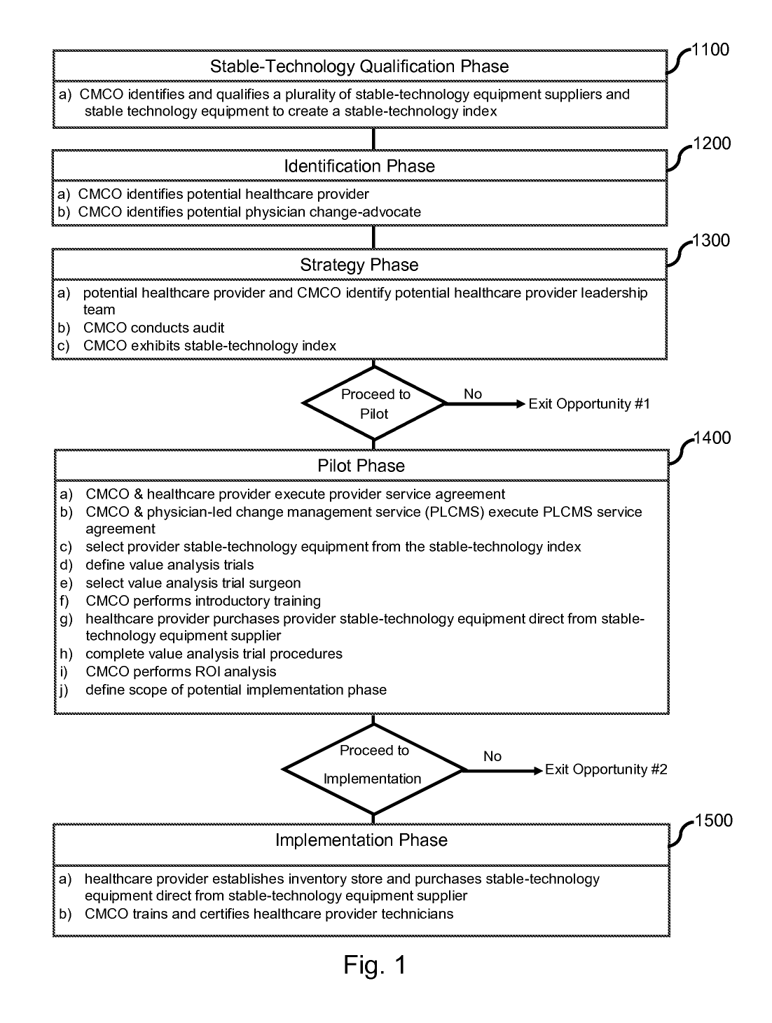

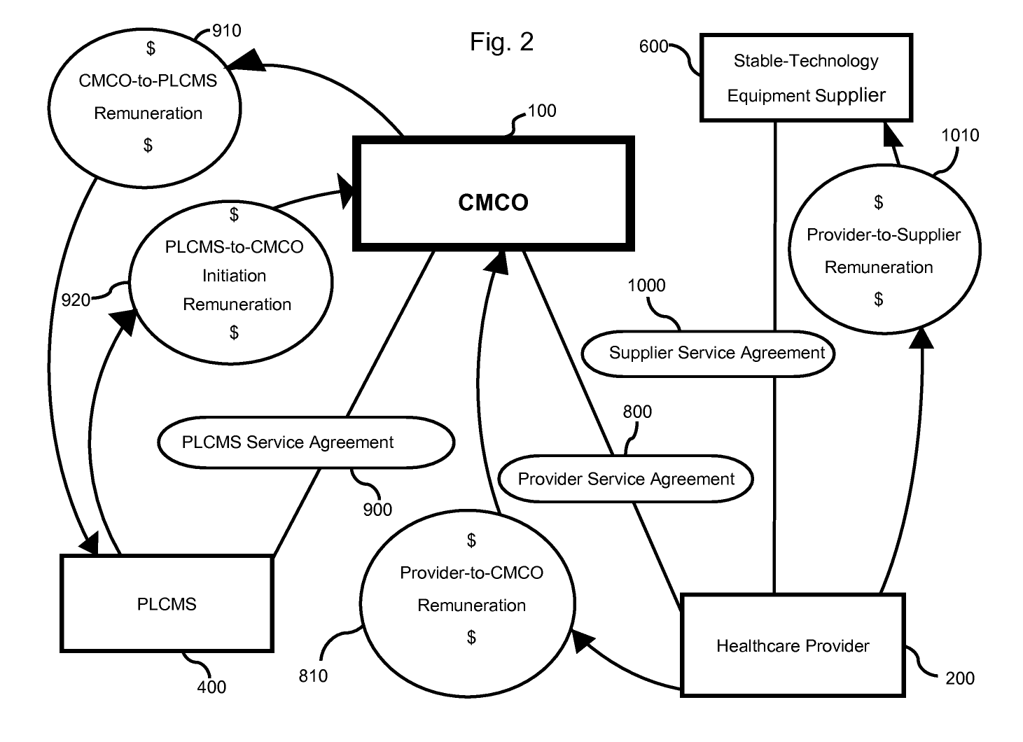

The claimed method and system of aligning physician and hospital objectives to reduce the cost of medical procedures and enables a significant advance in the state of the art. In one embodiment the healthcare equipment supply chain method is led by a change management and certification organization CMCO (100) positioned to align a healthcare provider (200), a physician-led change management service PLCMS (400), and a stable-technology equipment supplier (600), to identify and facilitate the direct purchase of stable-technology equipment (500) from the stable-technology equipment supplier (600) by the healthcare provider (200). With reference now to FIGS. 1 and 2, one such embodiment includes a step of identification and qualification, by the change management and certification organization CMCO (100), of a plurality of stable-technology equipment suppliers (600) and a plurality of stable-technology equipment (500), to create a stable-technology index.

The method may also include the step of establishing a relationship between the change management and certification organization CMCO (100) and the healthcare provider (200) via a provider service agreement (800) defining a provider-to-CMCO remuneration (810) and responsibilities, wherein the change management and certification organization CMCO (100) provides education and training to a plurality of healthcare provider personnel, and/or technicians, to become certified technicians. In one embodiment the provider-to-CMCO remuneration (810) is a fixed fee that is totally unrelated and independent of cost savings realized by the healthcare provider (200). The provider service agreement (800) is preferably a contract with a term of at least 12 months, more preferably at least 24 months, and even more preferred, at least 36 months.

The method may further include the step of establishing a relationship between the change management and certification organization CMCO (100) and the physician-led change management service PLCMS (400) via a PLCMS service agreement (900) defining responsibilities and at least (i) a PLCMS-to-CMCO initiation remuneration (920) paid by the physician-led change management service PLCMS (400) to the change management and certification organization CMCO (100), and (ii) a CMCO-to-PLCMS remuneration (910) paid by the change management and certification organization CMCO (100) to the physician-led change management service PLCMS (400), wherein the physician-led change management service PLCMS (400) provides a PLCMS site mentor to the healthcare provider (200) to provide technical support of the stable-technology equipment (500), and a physician change-advocate to promote the use of the stable-technology equipment (500). The PLCMS site mentor provides teaching, training, and coaching to the personnel of the healthcare provider.

The method may even further include the step of establishing a relationship between the healthcare provider (200) and at least one stable-technology equipment supplier (600) from the stable-technology index via a supplier service agreement (1000) for the direct purchase of the stable-technology equipment (500) and defining a provider-to-supplier remuneration (1010) paid directly from the healthcare provider (200) to the stable-technology equipment supplier (600).

Additionally the method may include a compliance step to ensure there is no financial consideration exchanged between the stable-technology equipment supplier (600) and the change management and certification organization CMCO (100). The change management and certification organization CMCO (100) is vendor neutral and product agnostic.

These relationships are illustrated in FIG. 2 showing the relationships between the parties and the flow of remuneration. The change management and certification organization CMCO (100) provides a method, or process, and system for the physician-led change management service PLCMS (400) and the stable-technology equipment supplier (600) to work together and eliminate traditional middlemen and replace them by teaching, training and coaching healthcare provider personnel in a apprenticeship and mentoring program, thereby improving the skills, knowledge, and experience level of the healthcare provider personnel. The outcome of educating the healthcare provider personnel regarding stable-technology equipment and implementing an embodiment of this method allows healthcare providers (200) to acquire stable-technology equipment (500) at value propositions not previously possible, thereby reducing the costs of medical equipment without compromising the quality of the service levels. Establishing these defined relationships allows the healthcare provider (200) to “take back control” of their operating rooms, service lines, and equipment purchasing, while doing so in a manner that includes and engages the physicians to ensure quick adoption of the method and compensate physicians accordingly, while ensuring compliance with federal laws and ensure that the change management and certification organization CMCO (100) and the physician-led change management service PLCMS (400) do not fall within the definition of a “designated health service” within the federal Stark laws.

FIG. 1 illustrates numerous embodiments and identifies potential phases of the method. For instance, one embodiment may include a stable-technology qualification phase (1100) whereby the change management and certification organization CMCO (100) identifies and qualifies a plurality of stable-technology equipment suppliers (600) that are willing to eliminate the middlemen and accept equipment orders directly from healthcare providers (200). The change management and certification organization CMCO (100) analyzes the stable-technology equipment (500) of the stable-technology equipment suppliers (600) to determine whether it is the equivalent of commonly used branded equipment. If the stable-technology equipment (500) meets the requirements of the change management and certification organization CMCO (100) then it is added to a stable-technology index that is organized and managed by the change management and certification organization CMCO (100). The stable-technology index may be thought of as a catalogue, or database, containing qualified, or approved, stable-technology equipment (500) and associating it with the equivalent commonly used branded equipment.

The method may also include an identification phase (1200) wherein the change management and certification organization CMCO (100) identifies potential healthcare providers (200) that may be interested in the direct-access purchase method. Next, the change management and certification organization CMCO (100) identifies physicians that are affiliated with the potential healthcare provider (200) and evaluates their potential as a potential physician change-advocate. The change management and certification organization CMCO (100) analyzes the physicians relationship with the potential healthcare provider (200), the influence they have with the healthcare provider (200) and other associated physicians, and the amount of work they perform. Eventually the change management and certification organization CMCO (100) selects one, or more, of the physicians to fulfill the role of the potential physician change-advocate. The physicians are screened to identify innovators, or early adopters, and are the type of physician that is likely to embrace the direct-access stable technology system and method. In one embodiment of this step the physicians are asked by the healthcare provider to complete a survey and the survey results are used to identify the likely early adopters. The step of conducting physician audits assists the change management and certification organization CMCO (100) in selecting the preferred early adopter physician, which is pivotal in aligning the goals of the healthcare provider (200) and the goals of the physicians. The change management and certification organization CMCO (100) identifies one or more of the early adaptors that understand that in order to lower implant spending, it's not about product, it's about work-flow redesign. In one embodiment these preferred early adopters were identified via a series of questions on a survey suggesting that they believe that the most strategic decision one can make to lower implant spending is to remove the sales representative from the OR and take back the responsibility of managing implant services.

Then the change management and certification organization CMCO (100) establishes a strategy phase (1300) with the potential healthcare provider (200) and a leadership and implementation team associated with the potential healthcare provider (200). The strategy phase (1300) is designed to warm everyone up to the concept and appreciate the magnitude of the potential change as well as the potential cost savings. The strategy phase (1300) includes an audit of the healthcare provider's records over an agreed upon audit, or analysis, period. The audit may be performed by the change management and certification organization CMCO (100) or a data analyzer designed to access and evaluate the potential healthcare provider's records, as will be explained later in greater detail. The change management and certification organization CMCO (100) shows the potential healthcare provider the stable-technology index and educates the healthcare provider how the stable-technology equipment (500) is functionally equivalent to the equipment currently being used by the potential healthcare provider (200), and the cost savings that could have been achieve if items from the stable-technology index were used during the audit period. The potential physician change-advocate may also be involved in the strategy phase. The strategy phase may further include the identification of a potential scope of a pilot phase (1400) to prove out the method and potential savings. The healthcare provider (200) now decides whether to proceed to the pilot phase (1400), hence the exit opportunity #1 shown in FIG. 1 giving the potential healthcare provider (200) the chance to decide this is not a process for their organization and conclude the process.

In one embodiment the first interaction between the change management and certification organization CMCO (100) and the healthcare provider (200) involves the change management and certification organization CMCO (100) meeting the healthcare provider's (200) leadership team to determining whether the healthcare provider (200) has the ability to embrace this system and method. This strategy phase includes a site visit, or multiple site visits, by the change management and certification organization CMCO (100) to complete an orientation/due diligence process for both the healthcare provider (200) and the change management and certification organization CMCO (100). The strategy phase (1300) may further include a leadership orientation to establish the change objectives and create a climate for change. The leadership orientation may include one or more of the following: (1) a review of the guiding principles and core values of the change management and certification organization CMCO (100), (2) the definition of a healthcare provider specific strategy and vision, (3) an analysis of the roles and responsibilities of an implementation team, (4) an introduction of the potential physician change-advocate, (5) education regarding the value analysis trial process and projected return on investment, (6) education regarding the role of a strategic communication process and the value of repetitive and consistent communication, and (7) a stable-technology education and review session.

If the parties proceed to the pilot phase (1400) the change management and certification organization CMCO (100) and the healthcare provider (200) execute a provider service agreement (800). In one embodiment the provider service agreement (800) is a contingent provider service agreement (800), meaning that they have at least one additional exit opportunity, shown as exit opportunity #2 in FIG. 1. In one embodiment it is at this point that the potential physician change-advocate determines if this is a process they want to be involved with, and if so they form an organization designated the physician-led change management service PLCMS (400) and execute the PLCMS service agreement (900) with the change management and certification organization CMCO (100) and become the official physician change-advocate. In one embodiment the physician change-advocate must be an owner, member, shareholder, or member of the physician-led change management service PLCMS (400), depending on the form of the organization.

In a further embodiment the PLCMS service agreement (900) meets the franchise requirements of the Federal Trade Commission. Thus, in one embodiment the PLCMS service agreement (900) defines a PLCMS-to-CMCO initiation remuneration (920) that is paid by the physician-led change management service PLCMS (400) to the change management and certification organization CMCO (100). Further, the PLCMS service agreement (900) defines a CMCO-to-PLCMS remuneration (910) that is paid by the change management and certification organization CMCO (100) to the physician-led change management service PLCMS (400). Additionally the PLCMS service agreement (900) establishes the quality control requirements of the change management and certification organization CMCO (100) that must be met by the physician-led change management service PLCMS (400), as well as defining the requirements of the physician change-advocate.

Additionally, the provider service agreement (800) defines a provider-to-CMCO remuneration (810) that is paid by the healthcare provider (200) to the change management and certification organization CMCO (100) in exchange for their consulting regarding the implementation of the direct-access purchase system and training and certification of technicians. In one particular embodiment the PLCMS service agreement (900) defines a CMCO-to-PLCMS remuneration (910) as a percentage of the provider-to-CMCO remuneration (810), and in a further embodiment the CMCO-to-PLCMS remuneration (910) is at least 50% of the provider-to-CMCO remuneration (810), while in an even further embodiment the CMCO-to-PLCMS remuneration (910) is at least 75% of the provider-to-CMCO remuneration (810), and in yet a further embodiment the CMCO-to-PLCMS remuneration (910) is at least 85% of the provider-to-CMCO remuneration (810). In one embodiment the provider-to-CMCO remuneration (810) is totally unrelated and independent of cost savings realized by the healthcare provider (200), therefore the provider-to-CMCO remuneration (810) is totally unrelated and independent of cost savings realized by the healthcare provider (200).

In yet another embodiment the PLCMS service agreement (900) requires that the physician-led change management service PLCMS (400) warrant, and/or periodically certify, that the physician-led change management service PLCMS (400) will not, or has not, accepted any financial consideration from any stable-technology equipment supplier (600). Likewise, in another embodiment the provider service agreement (800) requires that the change management and certification organization CMCO (100) warrant, and/or periodically certify, that the change management and certification organization CMCO (100) will not, or has not, accepted any financial consideration from any stable-technology equipment supplier (600). This method ensures compliance with federal anti-kickback law and is designed to prevent the inducement of referrals.

Returning again to the pilot phase of FIG. 1, in another embodiment it is at this point that stable-technology equipment is selected for the pilot phase. For example, one healthcare provider (200) may decide that they want to limit the pilot phase to total knee replacement procedures and may only select stable-technology equipment from one total knee stable-technology equipment supplier (600) for the pilot phase. Limiting the pilot phase to a particular service line, such as orthopedics, and a particular procedure, such as total knee procedures, allows the healthcare provider (200) to test the direct-access stable-technology purchase method without having to introduce widespread change all at one time. In other words, the pilot phase is intended to define and conduct a value analysis trial to demonstrate to the healthcare provider (200) the improvements that the method may offer the institution and the potential cost savings. As such, one step in the trial phase may be to select one or more value analysis trial surgeons to establish proof of the concept. In one embodiment the physician change advocate is the value analysis trial surgeon. Another step in the trial phase is for the change management and certification organization CMCO (100) to perform introductory training to select personnel of the healthcare provider (200) and assist the healthcare provider (200) in the direct purchase of the stable-technology equipment from at least one of the stable-technology equipment suppliers (600). Thus, in one particular narrowly tailored pilot phase less than five value analysis trial surgeons are selected, one of which may also be the physician change-advocate, and the value analysis trial is defined as a limited quantity, perhaps five, total knee replacement procedures per value analysis trial surgeon using stable-technology equipment from less than five stable-technology equipment suppliers (600). Upon completion of the value analysis trial procedures the change management and certification organization CMCO (100) completes a clinical evaluation analysis and a return-on-investment (ROI) analysis illustrating the change-advocates experience with the stable-technology and the cost savings associated with the direct-access purchase model compared to exact prior procedures. Upon completion of the value analysis trials the change management and certification organization CMCO (100) may define the scope and procedures necessary to move on to an implementation phase (1500). It is at this point that the healthcare provider (200) is presented with exit opportunity #2 to elect not to move forward with the implementation phase if the change management and certification organization CMCO (100) has not demonstrated adequate cost savings.

Finally, the change management and certification organization CMCO (100) and the healthcare provider (200) establish an implementation plan, which may be a staggered implementation plan based upon service lines, for example orthopedics, cardiovascular, urology, etc., or even further based upon procedures within a service line, for example, knees, hips, spine, elbow, shoulder, ankle, etc. In this phase the physician-led change management service PLCMS (400) assumes the responsibility to train and certify healthcare provider technicians. In another embodiment physician-led change management service PLCMS (400) assigns physician change-advocates the responsibility for successfully implementing a CMCO defined technician certification curriculum. The present method is not only about replacing traditional medical equipment sales representatives with trained hospital employees, it's about a total transformation of the healthcare provider's supply chain, changing the procurement process from being “reactive” to more of a “proactive” process. The ongoing process equips healthcare providers (200) with more knowledge and insight, enabling them to make better procurement decisions. The implementation phase is a transformation process intended to institutionalize the direct-access stable-technology process. This phase is intended to define and empower the implementation team and launch a communication campaign, embed a physician-led change management service PLCMS (400) site mentor to train and coach personnel of the healthcare provider and launch the technician education and certification program, establish an inventory store, transition new workflow responsibilities, and expand the direct-access stable-technology methodology to additional disciplines. In one embodiment the change management and certification organization CMCO (100) manages the strategy phase (1300) and the pilot phase (1400), while the physician-led change management service PLCMS (400) manages the implementation phase (1500).

The physician-led change management service PLCMS (400) ensures that the healthcare provider's personnel cultivate a team atmosphere and bring years of experience, expertise, and ‘know-how’ to ensure quality and consistency as a healthcare provider transitions away from being dependent on salesmen and company support. In one embodiment the technician certification process is modeled on how the industry trains sales representatives—through observation, practice, and coaching over time. The content is designed to use current knowledge combined with new processes and skills. Upon becoming a certified technician the technician is fully capable of providing consistent and timely feedback to make certain of successful integration, while ensuring that healthcare provider employees are more actively involved in the inventory, the operating room, and the distribution chain.

The technician certification training modules are developed for various types of learners, incorporating blended training tactics that include instructional-led or classroom teaching, on-line resources and site certified technicians who focus on behavior change, one person at a time. In one embodiment the training includes at least 30 modules and 300 hours of coursework directed to (a) Business Speak & Leadership, (b) Pre, Peri and Post operative process, and (c) Product & Procedure Knowledge. The time spent on each module will vary slightly based on the technician's level of experience. Certification may require the passage of a test directed to each module.

In another embodiment the stable-technology equipment supplier (600) executes a supplier service agreement (1000) with the healthcare provider (200). In one such embodiment the supplier service agreement (1000) requires that the stable-technology equipment supplier (600) warrant, and/or periodically certify, that the stable-technology equipment supplier (600) will not, or has not, provided any financial consideration to the physician-led change management service PLCMS (400) and/or the change management and certification organization CMCO (100).

In one embodiment the change management and certification organization CMCO (100) audits at least a portion of the potential healthcare provider's records over an audit period to determine a quantity of recurring healthcare equipment purchases that are compatible with stable-technology equipment (500) in the stable-technology index, in an effort to identify redundancy and waste. In another embodiment the auditing is performed by a data analyzer and includes the steps of (a) establishing a connection between a data analyzer and the potential healthcare provider's records, (b) analyzing the potential healthcare provider's records during the audit period with the data analyzer, by using at least one processor, to automatically identify recurring healthcare equipment appearing in the potential healthcare provider's records during the audit period in a recurring healthcare equipment quantity greater than a predetermined healthcare equipment quantity, (c) determining, by using the at least one processor, the recurring healthcare equipment that are compatible with stable-technology equipment (500) in the stable-technology index by identifying at least one recurring healthcare equipment attribute and transforming it into at least one stable-technology equipment attribute and identifying an equivalent stable-technology equipment (500) in the stable-technology index, and, in some embodiments, (d) determining a compatible recurring healthcare equipment stable-technology cost savings.

The method is identifying healthcare equipment purchases that occur multiple times within an audit, or analysis, period. The method is looking at purchases of traditional physician preference items such as implants, as well as ancillary healthcare equipment purchases of items such as saw blades, drills, guide wires, burrs, etc. The data analyzer may be utilized in a number of ways to analyze the records, for instance it may deployed locally into the healthcare provider's electronic records, alternatively equipment purchasing records may be exported and fed to the data analyzer. The data analyzer may reside locally on a piece of hardware at the healthcare provider, it may reside remotely on a separate piece of hardware that is in communication with the healthcare provider, and it may reside remotely on a separate piece of hardware that is not in communication with the healthcare provider. In one embodiment the audit period is at least one month, while in another embodiment the audit period is at least three months, and in yet a further embodiment the audit period is at least six months. The predetermined healthcare equipment quantity may be adjustable, and in the broadest embodiment is at least two, however in another embodiment the predetermined healthcare equipment quantity is at least ten, while in yet a further embodiment it is at least one-hundred.

In a particular embodiment the stable-technology index includes an electronic stable-technology database containing at least 100 stable-technology equipment correlated with at least 100 common recurring healthcare equipment with each having a unique recurring equipment identification code, wherein the at least one recurring healthcare equipment attribute is the unique recurring equipment identification code, and the auditing step includes the steps of (a) establishing a connection between the data analyzer and the electronic stable-technology database, (b) searching, by using the at least one processor, the potential healthcare provider's records and identifying a plurality of compatible entries having the unique recurring equipment identification codes contained in the electronic stable-technology database, and, in some embodiments, (c) transforming the plurality of compatible entries, by using the at least one processor, into a compatible recurring equipment stable-technology report. The at least one recurring healthcare equipment attribute may be a description of the equipment used in the records, a stockkeeping unit or SKU, or a unique device identifier or portion of the FDA's unique device identification system (UDI), a size, a orientation, materials of construction, just to name a few.

In one particular embodiment the method focuses on the healthcare equipment that most likely represents the greatest potential source of savings, namely physician preference items, while in an even further embodiment the category of physician preference items is further narrowed to physician preference implant items. Thus, in one embodiment the auditing step includes the steps of (a) establishing a connection between a data analyzer and the potential healthcare provider's records, (b) analyzing the potential healthcare provider's records during the audit period with the data analyzer, by using at least one processor, to automatically identify physician preference items that are compatible with stable-technology equipment (500) in the stable-technology index by identifying at least one physician preference item attribute and transforming it into at least one stable-technology attribute and identifying an equivalent stable-technology equipment (500) in the stable-technology index, and, in a further embodiment, (c) determining a compatible PPI stable-technology cost savings. In yet another embodiment the stable-technology index includes an electronic stable-technology database containing at least 100 stable-technology equipment correlated with at least 100 common physician preference items with each having a unique PPI identification code, wherein the at least one physician preference item attribute is the unique PPI identification code, and in another embodiment the auditing step includes the steps of (a) establishing a connection between the data analyzer and the electronic stable-technology database, (b) searching, by using the at least one processor, the potential healthcare provider's records and identifying a plurality of compatible entries having the unique PPI identification codes contained in the electronic stable-technology database, and, in some embodiments, (c) transforming the plurality of compatible entries, by using the at least one processor, into a compatible PPI stable-technology report. The at least one physician preference item attribute may be a description of the equipment used in the records, a trade name, a stockkeeping unit or SKU, or a unique device identifier or portion of the FDA's unique device identification system (UDI), just to name a few.

A physician preference items is a product about which physicians have strong preferences. At a minimum physician preference items include hip and knee implants, cardiac stents, and spine implants. Although hospitals are the actual purchasers of physician preference items, it is physicians (surgeons) who determine which device to use for a particular patient and procedure. Surgeons' decisions are frequently based on factors not related to cost that may reflect their personal experience with a particular product, their assessments of a particular patient's interests, as well as their relationships with the manufacturers' representatives. Thus, there may be a disconnect between the hospital's cost containment goals and physicians' preferences.

In another embodiment the auditing step identifies another important metric, namely the identification of healthcare equipment items that are repeatedly purchased but are not associated with stable-technology equipment (500) in the stable-technology index. In this embodiment the data analyzer, by using the least one processor, automatically identifies recurring healthcare equipment from the audit period that is not compatible with stable-technology equipment (500) in the stable-technology index. In another embodiment a stable-technology indicator is created by comparing the quantity of automatically identified recurring healthcare equipment during the audit period with at least one of (i) the quantity of compatible stable-technology equipment during the audit period, or (ii) the quantity of non-compatible stable-technology equipment during the audit period.

In one embodiment the stable-technology indicator is the ratio of the quantity of compatible stable-technology equipment during the audit period to the quantity of automatically identified recurring healthcare equipment during the audit period. In this embodiment the stable-technology indicator should be decreasing during the implementation phase as the numerator gets smaller as the data analyzer identifies less, and less, compatible stable-technology equipment is identified because more of the identified recurring purchases are stable-technology equipment purchases and therefore are not identified as having compatible stable-technology equipment in the stable-technology index.

In one embodiment the data analyzer is configured to run and determine the stable-technology indicator at predetermined indicator intervals. In a further embodiment the predetermined indicator intervals are adjustable. In another embodiment if a newly determined stable-technology indicator is not less than the previously determined stable-technology indicator then the data analyzer automatically communicates this to the change management and certification organization (CMCO) (100); while in another embodiment the data analyzer automatically communicates this to the healthcare provider (200); while in yet another embodiment the data analyzer automatically communicates this to the physician-led change management service (PLCMS) (400). The stable-technology indicator provides a quick and easy to understand measure as to who is doing their job and how well the healthcare provider is embracing the change to a stable-technology direct-access purchasing methodology.

Another embodiment incorporates the step of establishing an electronic stable-technology exchange to analyze and control, by using at least one processor, the direct purchases of the healthcare provider (200) from the at least one stable-technology equipment supplier (600) from the stable-technology index. In one such embodiment the electronic stable-technology exchange makes it possible for the at least one stable-technology equipment supplier (600) to submit at least one stable-technology equivalence proposal directly on the electronic stable-technology exchange. The electronic stable-technology exchange may alert the change management and certification organization CMCO (100) when a stable-technology equivalence proposal is received. Next the change management and certification organization CMCO (100) analyzes and qualifies the at least one stable-technology equivalence proposal so that the qualified stable-technology equipment (500) from the at least one stable-technology equivalence proposal may be added to an electronic stable-technology database. One goal of this embodiment is to establish an easy to use system that encourages the stable-technology equipment suppliers (600) to assist in populating the electronic stable-technology database via a convenient stable-technology equivalence proposal system. In a further embodiment a connection between a data analyzer and the healthcare provider's records is established and the healthcare provider's records are analyzed during an analysis period with the data analyzer, by using at least one processor, to automatically identify recurring healthcare equipment that are compatible with stable-technology equipment (500) in the stable-technology index. In one embodiment such compatibility is determined by identifying at least one recurring healthcare equipment attribute and transforming it into at least one stable-technology equipment attribute and identifying an equivalent stable-technology equipment (500) in the stable-technology index. The healthcare provider (200) is provided access to a provider specific portion of the electronic stable-technology exchange wherein the provider specific portion contains the equivalent stable-technology equipment (500) identified by the data analyzer, and the electronic stable-technology exchange facilitates a direct purchase by the healthcare provider of at least one of the equivalent stable-technology equipment (500) in the provider specific portion.

Yet a further embodiment of the method also includes the steps of (a) analyzing the healthcare provider's records during the analysis period with the data analyzer, by using at least one processor, to automatically identify recurring healthcare equipment appearing in the healthcare provider's records during the analysis period in a recurring healthcare equipment quantity greater than a predetermined healthcare equipment quantity, (b) determining, by using the at least one processor, the recurring healthcare equipment that are compatible with stable-technology equipment (500) in the stable-technology index by identifying at least one recurring healthcare equipment attribute and transforming it into at least one stable-technology equipment attribute and identifying an equivalent stable-technology equipment (500) in the stable-technology index, and (c) providing the healthcare provider (200) access to the provider specific portion of the electronic stable-technology exchange wherein the provider specific portion contains the equivalent stable-technology equipment (500) identified by the data analyzer. In an even further embodiment the stable-technology index includes an electronic stable-technology database containing at least 100 stable-technology equipment correlated with at least 100 common recurring healthcare equipment with each having a unique recurring equipment identification code. The at least one recurring healthcare equipment attribute may be the unique recurring equipment identification code. The method may further include the steps of (a) searching, by using the at least one processor, the healthcare provider's records and identifying a plurality of compatible entries having the unique recurring equipment identification codes contained in the electronic stable-technology database, and (b) providing the healthcare provider (200) access to the provider specific portion of the electronic stable-technology exchange wherein the provider specific portion contains the recurring equivalent stable-technology equipment (500) identified by the data analyzer.

An additional embodiment incorporates a compliance analyzer that may monitor the financial records of the change management and certification organization CMCO (100) and/or the physician-led change management service PLCMS (400), and report compliance to the healthcare provider (200). This embodiment also includes the steps of (a) establishing a connection between a compliance analyzer and the financial records of the change management and certification organization CMCO (100), (b) analyzing the financial records of the change management and certification organization CMCO (100) during a compliance period with the compliance analyzer, by using at least one processor, to automatically identify the receipt of financial consideration exchanged between the stable-technology equipment supplier (600) and the change management and certification organization CMCO (100), and (c) generating and electronically transmitting to the healthcare provider (200) a compliance report. A further embodiment includes the steps of (a) establishing a connection between a compliance analyzer and the financial records of the physician-led change management service PLCMS (400), (b) analyzing the financial records of the physician-led change management service PLCMS (400) during the compliance period with the compliance analyzer, by using at least one processor, to automatically identify the receipt of financial consideration exchanged between the stable-technology equipment supplier (600) and the physician-led change management service PLCMS (400), and (c) generating and electronically transmitting to the healthcare provider (200) the compliance report. In one embodiment the compliance analyzer is configured to run and produce compliance reports at predetermined compliance intervals. In a further embodiment the predetermined compliance intervals are adjustable. In an even further embodiment the compliance reports are produced and saved within the stable-technology exchange (710).

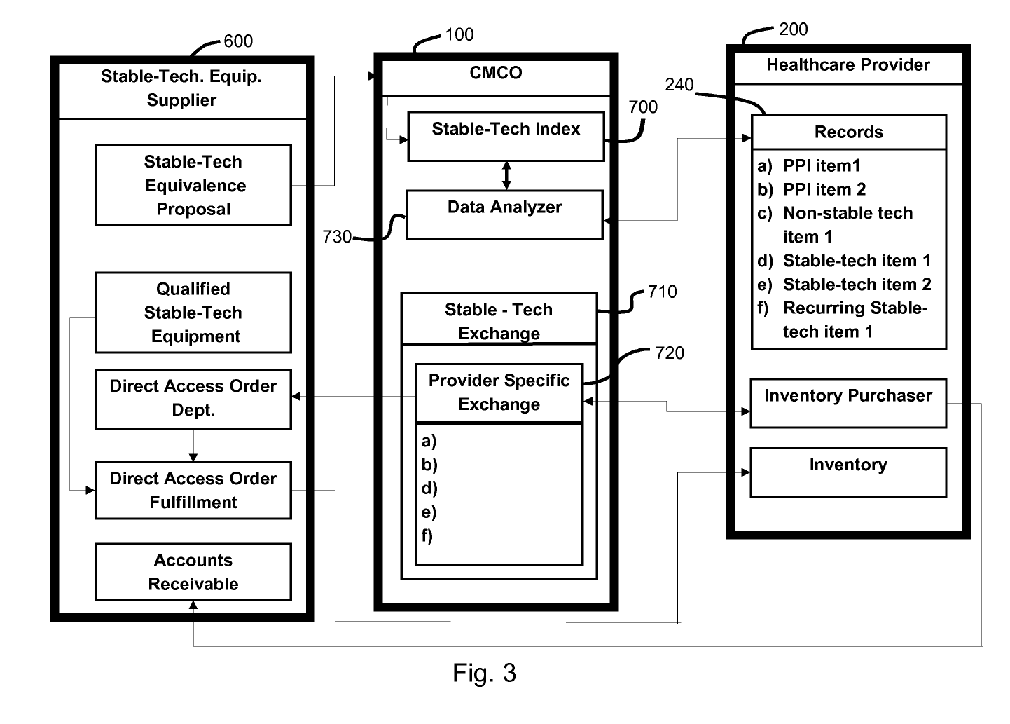

With general reference to FIG. 3, in one embodiment the process includes a computer-implemented method to analyze records of a healthcare provider (200) and create a stable-technology exchange (710) for the direct purchase of stable-technology equipment (500) from a stable-technology equipment supplier (600). This embodiment includes an auditing step in which a plurality of records of the healthcare provider (300) are examined and transformed with a data analyzer and a processor. This embodiment may also include a step of identifying a plurality of recurring healthcare equipment appearing in the records in a recurring healthcare equipment quantity greater than a predetermined recurring equipment quantity and are compatible with at least one stable-technology equipment (500) by comparing the records and an electronic stable-technology database listing qualified stable-technology equipment, with the data analyzer and the processor. This embodiment may also include the step of establishing an electronic stable-technology exchange to analyze and control the direct purchases, by the healthcare provider (200) from the at least one stable-technology equipment supplier (600), from a provider specific portion of the electronic stable-technology exchange. One particular embodiment includes an access control module that filters the compatible stable-technology equipment (500) identified by the data analyzer so that the provider specific portion of the electronic stable-technology exchange only contains compatible stable-technology equipment (500) for healthcare provider qualified procedures by the access control module comparing the compatible stable-technology equipment (500) with a healthcare provider qualified procedure list indicating completion of stable-technology procedure training. In other words, a master electronic stable-technology exchange may exist and contain healthcare equipment from every potential practice area and service line, yet the access control module ensures that a particular healthcare provider (200) will only be able to see, access, and order from portions of the electronic stable-technology exchange directed to procedures and equipment that the particular healthcare provider (200) has been trained and certified, which are saved, accessed, and evaluated in the healthcare provider qualified procedure list. Finally, the method includes the step of providing the healthcare provider (200) access to the provider specific portion of the electronic stable-technology exchange and the ability to make a direct purchase from the stable-technology equipment supplier (600) of at least one of the compatible stable-technology equipment (500) in the provider specific portion. This embodiment may further include any of the previously described steps such as those associated with the receipt and control of the at least one stable-technology equivalence proposal, the compliance analyzer, and the stable-technology indicator, just to name a few and avoid excessive repetition.

Further, in another embodiment the stable-technology exchange (710) also serves as the automated certification system periodically requiring one or more of the following: (a) the previously discussed certification that the physician-led change management service PLCMS (400) has not accepted any financial consideration from any stable-technology equipment supplier (600), (b) the previously discussed certification that the change management and certification organization CMCO (100) has not accepted any financial consideration from any stable-technology equipment supplier (600), and/or (c) the previously discussed certification that stable-technology equipment supplier (600) has not provided any financial consideration to the physician-led change management service PLCMS (400) and/or the change management and certification organization CMCO (100). Thus, in one embodiment the stable-technology exchange (710) automatically generates any of the above certifications and transmits it to the appropriate party at a predetermined certification interval. Further, the stable-technology exchange (710) may receive and store any of the above completed certifications in a healthcare provider specific compliance documentation record. In one particular embodiment the certifications are electronic declarations that must be electronically accepted or signed. In an even further embodiment access to the stable-technology exchange (710) is blocked until the party has completed the certification.

The stable-technology equipment described herein is a piece of medical equipment, often an implant, that is a public domain design, in other words one that is not covered by a patent, or patents, that are still enforceable, and can be through of as a “generic” piece of equipment. The stable-technology equipment will be time-tested safe products acquired via a direct-access procurement model thereby significantly reducing cost. In one embodiment the stable-technology equipment is branded for the specific healthcare provider (200) allowing the healthcare provider (200) to have its own private label brand.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The methods may incorporate a machine in the example form of a computer system within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a target machine in a server-target network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, the term “machine” shall also be taken to include any collection of machines that individually or jointly execute a set (or multiple sets) of instructions to perform any one or more of the methodologies discussed herein.

The computer system includes a processor (e.g., a central processing unit (CPU), a graphics processing unit (GPU) or both), a main memory and a static memory, which communicate with each other via a bus. The computer system may further include a video display unit (e.g., a liquid crystal display (LCD) or a cathode ray tube (CRT)). The computer system also includes an alpha-numeric input device (e.g., a keyboard), a user interface (UI) navigation device (e.g., a cursor control device), a disk drive unit, a signal generation device (e.g., a speaker), and a network interface device. The disk drive unit includes a machine-readable medium on which is stored one or more sets of instructions and data structures (e.g., software) embodying or utilized by any one or more of the methodologies or functions described herein. The software may also reside, completely or at least partially, within the main memory and/or within the processor during execution thereof by the computer system, with the main memory and the processor also constituting machine-readable media.

The software may further be transmitted or received over a network via the network interface device utilizing any one of a number of well-known transfer protocols (e.g., Hyper Text Transfer Protocol (HTTP)). The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, target or server computer system) or one or more processors may be configured by software (e.g., an application or application portion) as a hardware-implemented module that operates to perform certain operations as described herein. In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations. Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time. Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).) Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

The term “stable-technology” equipment supplier (600) is used throughout this application and is not intended to be limiting. In fact, it is intended to cover any equipment supplier. Likewise, the term “stable-technology” equipment (500) is used throughout this application. One skilled in the art will appreciate that this method may also be applied to equipment other than “stable-technology” equipment, and this application anticipates continuation and continuation-in-part applications directed to equipment other than “stable-technology” equipment. Thus, the term healthcare equipment may be substituted for any occurrence of stable-technology equipment throughout this document and when done so the term healthcare equipment is not limited to equipment that is characterized as a stable-technology.

Numerous alterations, modifications, and variations of the preferred embodiments disclosed herein will be apparent to those skilled in the art and they are all anticipated and contemplated to be within the spirit and scope of this application. For example, although specific embodiments have been described in detail, those with skill in the art will understand that the preceding embodiments and variations can be modified to incorporate various types of substitute and or additional or alternative steps, procedures, and the order for such steps and procedures. Accordingly, even though only few variations of the present methodology and system are described herein, it is to be understood that the practice of such additional modifications and variations and the equivalents thereof, are within the spirit and scope of this application. The corresponding structures, materials, acts, and equivalents of all methods, means, and steps plus function elements in the claims below are intended to include any structure, material, or acts for performing the functions in combination with other claimed elements as specifically claimed.

We claim:

1. A healthcare equipment supply chain method led by a change management and certification organization CMCO to align a healthcare provider, a physician-led change management service PLCMS, and a stable-technology equipment supplier to identify and facilitate the direct purchase of stable-technology equipment from the stable-technology equipment supplier by the healthcare provider, and control the transfer of funds, comprising the steps of:
a) identification and qualification, by the change management and certification organization CMCO, of a plurality of stable-technology equipment suppliers and a plurality of stable-technology equipment, to create a stable-technology index;
b) establishing a relationship between the change management and certification organization CMCO and the healthcare provider via a provider service agreement defining a provider-to-CMCO remuneration and responsibilities, wherein the change management and certification organization CMCO provides training to a plurality of healthcare provider technicians to become certified technicians;
c) establishing a relationship between the change management and certification organization CMCO and the physician-led change management service PLCMS via a PLCMS service agreement defining responsibilities and at least (i) a PLCMS-to-CMCO initiation remuneration paid by the physician-led change management service PLCMS to the change management and certification organization CMCO, and (ii) a CMCO-to-PLCMS remuneration paid by the change management and certification organization CMCO to the physician-led change management service PLCMS, wherein the physician-led change management service PLCMS provides a PLCMS site mentor to the healthcare provider to provide technical support of the stable-technology equipment, and a physician change-advocate to promote the use of the stable-technology equipment;
d) establishing a relationship between the healthcare provider and at least one stable-technology equipment supplier from the stable-technology index via a supplier service agreement for the direct purchase of the stable-technology equipment and defining a provider-to-supplier remuneration paid directly from the healthcare provider to the stable-technology equipment supplier; and
e) wherein there is no financial consideration exchanged between the stable-technology equipment supplier and the change management and certification organization CMCO.

2. The method of claim 1, wherein there is no financial consideration exchanged between the stable-technology equipment supplier and the physician-led change management service PLCMS.

3. The method of claim 1, further including the step of identification, by the change management and certification organization CMCO, of a potential healthcare provider and a potential physician change-advocate with a practice associated with the potential healthcare provider, wherein the potential healthcare provider becomes the healthcare provider upon execution of the provider service agreement, and the potential physician change-advocate becomes the physician change-advocate upon formation the physician-led change management service PLCMS and execution of the PLCMS service agreement, and wherein the physician change-advocate is an owner of the physician-led change management service PLCMS.

4. The method of claim 1, further including the step of auditing, by the change management and certification organization CMCO, of at least a portion of the potential healthcare provider's records over an audit period to determine a quantity of recurring healthcare equipment purchases that are compatible with stable-technology equipment in the stable-technology index.

5. The method of claim 4, wherein the auditing step includes the steps of (a) establishing a connection between a data analyzer and the potential healthcare provider's records, (b) analyzing the potential healthcare provider's records during the audit period with the data analyzer, by using at least one processor, to automatically identify recurring healthcare equipment appearing in the potential healthcare provider's records during the audit period in a recurring healthcare equipment quantity greater than a predetermined healthcare equipment quantity, (c) determining, by using the at least one processor, the recurring healthcare equipment that are compatible with stable-technology equipment in the stable-technology index by identifying at least one recurring healthcare equipment attribute and transforming it into at least one stable-technology equipment attribute and identifying an equivalent stable-technology equipment in the stable-technology index, and (d) determining a compatible recurring healthcare equipment stable-technology cost savings.

6. The method of claim 5, wherein the stable-technology index includes an electronic stable-technology database containing at least 100 stable-technology equipment correlated with at least 100 common recurring healthcare equipment with each having a unique recurring equipment identification code, wherein the at least one recurring healthcare equipment attribute is the unique recurring equipment identification code, and the auditing step includes the steps of (a) establishing a connection between the data analyzer and the electronic stable-technology database, (b) searching, by using the at least one processor, the potential healthcare provider's records and identifying a plurality of compatible entries having the unique recurring equipment identification codes contained in the electronic stable-technology database, and (c) transforming the plurality of compatible entries, by using the at least one processor, into a compatible recurring equipment stable-technology report.

7. The method of claim 4, wherein the auditing step includes the steps of (a) establishing a connection between a data analyzer and the potential healthcare provider's records, (b) analyzing the potential healthcare provider's records during the audit period with the data analyzer, by using at least one processor, to automatically identify physician preference items that are compatible with stable-technology equipment in the stable-technology index by identifying at least one physician preference item attribute and transforming it into at least one stable-technology attribute and identifying an equivalent stable-technology equipment in the stable-technology index, and (c) determining a compatible PPI stable-technology cost savings.

8. The method of claim 7, wherein the stable-technology index includes an electronic stable-technology database containing at least 100 stable-technology equipment correlated with at least 100 common physician preference items with each having a unique PPI identification code, wherein the at least one physician preference item attribute is the unique PPI identification code, and the auditing step includes the steps of (a) establishing a connection between the data analyzer and the electronic stable-technology database, (b) searching, by using the at least one processor, the potential healthcare provider's records and identifying a plurality of compatible entries having the unique PPI identification codes contained in the electronic stable-technology database, and (c) transforming the plurality of compatible entries, by using the at least one processor, into a compatible PPI stable-technology report.

9. The method of claim 5, wherein the auditing step includes the steps of the data analyzer, by using the least one processor, (a) automatically identifying recurring healthcare equipment from the audit period that are not compatible with stable-technology equipment in the stable-technology index, and (b) creating a stable-technology indicator by comparing the quantity of automatically identified recurring healthcare equipment during the audit period with at least one of (i) the quantity of compatible stable-technology equipment during the audit period, or (ii) the quantity of non-compatible stable-technology equipment during the audit period.

10. The method of claim 1, further including the step of:
(a) establishing an electronic stable-technology exchange to analyze and control, by using at least one processor, the direct purchases of the healthcare provider from the at least one stable-technology equipment supplier from the stable-technology index by:
(b) receiving at least one stable-technology equivalence proposal from the at least one stable-technology equipment supplier to the electronic stable-technology exchange;
(c) analyzing and qualifying the at least one stable-technology equivalence proposal by the change management and certification organization CMCO;
(d) adding, by using the at least one processor, the qualified stable-technology equipment from the at least one stable-technology equivalence proposal to an electronic stable-technology database;
(e) establishing a connection between a data analyzer and the healthcare provider's records;
(f) analyzing the healthcare provider's records during an analysis period with the data analyzer, by using at least one processor, to automatically identify recurring healthcare equipment that are compatible with stable-technology equipment in the stable-technology index by identifying at least one recurring healthcare equipment attribute and transforming it into at least one stable-technology equipment attribute and identifying an equivalent stable-technology equipment in the stable-technology index;
(g) providing the healthcare provider access to a provider specific portion of the electronic stable-technology exchange wherein the provider specific portion contains the equivalent stable-technology equipment identified by the data analyzer; and
(h) facilitating a direct purchase by the healthcare provider of at least one of the equivalent stable-technology equipment in the provider specific portion.

11. The method of claim 10, further including the steps of (a) analyzing the healthcare provider's records during the analysis period with the data analyzer, by using at least one processor, to automatically identify recurring healthcare equipment appearing in the healthcare provider's records during the analysis period in a recurring healthcare equipment quantity greater than a predetermined healthcare equipment quantity, (b) determining, by using the at least one processor, the recurring healthcare equipment that are compatible with stable-technology equipment in the stable-technology index by identifying at least one recurring healthcare equipment attribute and transforming it into at least one stable-technology equipment attribute and identifying an equivalent stable-technology equipment in the stable-technology index, and (c) providing the healthcare provider access to the provider specific portion of the electronic stable-technology exchange wherein the provider specific portion contains the equivalent stable-technology equipment identified by the data analyzer.

12. The method of claim 11, wherein the stable-technology index includes an electronic stable-technology database containing at least 100 stable-technology equipment correlated with at least 100 common recurring healthcare equipment with each having a unique recurring equipment identification code, wherein the at least one recurring healthcare equipment attribute is the unique recurring equipment identification code, and further including the steps of (a) searching, by using the at least one processor, the healthcare provider's records and identifying a plurality of compatible entries having the unique recurring equipment identification codes contained in the electronic stable-technology database, and (b) providing the healthcare provider access to the provider specific portion of the electronic stable-technology exchange wherein the provider specific portion contains the recurring equivalent stable-technology equipment identified by the data analyzer.

13. The method of claim 1, further including the steps of (a) establishing a connection between a compliance analyzer and the financial records of the change management and certification organization CMCO, (b) analyzing the financial records of the change management and certification organization CMCO during a compliance period with the compliance analyzer, by using at least one processor, to automatically identify the receipt of financial consideration exchanged between the stable-technology equipment supplier (600) and the change management and certification organization CMCO, and (c) generating and electronically transmitting to the healthcare provider a compliance report.

14. The method of claim 13, further including the steps of (a) establishing a connection between a compliance analyzer and the financial records of the physician-led change management service PLCMS, (b) analyzing the financial records of the physician-led change management service PLCMS during the compliance period with the compliance analyzer, by using at least one processor, to automatically identify the receipt of financial consideration exchanged between the stable-technology equipment supplier and the physician-led change management service PLCMS, and (c) generating and electronically transmitting to the healthcare provider the compliance report.

15. A computer-implemented method to analyze records of a healthcare provider and create a stable-technology exchange for the direct purchase of stable-technology equipment from a stable-technology equipment supplier, comprising the steps of:
a) auditing, with a data analyzer and a processor, a plurality of records of the healthcare provider;
b) identifying, with the data analyzer and the processor, a plurality of recurring healthcare equipment appearing in the records in a recurring healthcare equipment quantity greater than a predetermined recurring equipment quantity and are compatible with at least one stable-technology equipment by comparing the records and an electronic stable-technology database listing qualified stable-technology equipment;
c) establishing an electronic stable-technology exchange to analyze and control, by using the processor, the direct purchases, by the healthcare provider from the at least one stable-technology equipment supplier, from a provider specific portion of the electronic stable-technology exchange, wherein an access control module filters the compatible stable-technology equipment identified by the data analyzer so that the provider specific portion of the electronic stable-technology exchange only contains compatible stable-technology equipment for healthcare provider qualified procedures by the access control module comparing the compatible stable-technology equipment with a healthcare provider qualified procedure list indicating completion of stable-technology procedure training; and
d) providing the healthcare provider access to the provider specific portion of the electronic stable-technology exchange and the ability to make a direct purchase from the stable-technology equipment supplier of at least one of the compatible stable-technology equipment in the provider specific portion.

16. The method of claim 15, further including the step of the electronic stable-technology exchange receiving and controlling the authorization, by using the processor, of at least one stable-technology equivalence proposal from the at least one stable-technology equipment supplier, adding the authorized stable-technology equipment from the at least one stable-technology equivalence proposal to the electronic stable-technology database.
